(19) United States
(12) Patent Application Publication
(10) Pub. No.: US 2015/0067828 A1
(43) Pub. Date: Mar. 5, 2015

(54) INDUSTRIAL AUTOMATION AND CONTROL DEVICE USER ACCESS

(71) Applicant: ABB Technology AG, Zurich (CH)

(72) Inventors: Fernando ALVAREZ, Untersiggenthal (CH); Frank Hohlbaum, Bad Sackingen (DE); Martin Meuli, Warth (CH)

(73) Assignee: ABB Technology AG, Zurich (CH)

(21) Appl. No.: 14/521,762

(22) Filed: Oct. 23, 2014

Related U.S. Application Data
(63) Continuation of application No. PCT/EP2013/058403, filed on Apr. 23, 2013.

(30) Foreign Application Priority Data
Apr. 23, 2012 (EP) 12165200.2

(51) Int. Cl. H04L 9/32; G06F 21/41

(52) U.S. Cl. CPC H04L 9/3268; G06F 21/41; H04L 9/3226; H04L 9/3271
USPC 726/19

(57) ABSTRACT

Solutions are disclosed for simplified user access to IEDs in industrial or utility operating environments such as those compatible with IEC 62351-8, having an LHMI with a restricted IED key set. A central Access Enabler assigns a short and temporary session secret to a previously authenticated user, and forwards the session secret to an IED for subsequent local user validation by the IED. A user session at the IED is remotely initiated by the Access Enabler, with the IED screen being instantaneously locked by the session secret.

### RELATED APPLICATION

This application claims priority as a continuation application under 35 U.S.C. §120 to PCT/EP2013/058403, which was filed as an International Application on Apr. 23, 2013 designating the U.S., and which claims priority to European Application 12165200.2 filed in Europe on Apr. 23, 2012. The entire contents of these applications are hereby incorporated by reference in their entireties.

### FIELD

The present disclosure relates to the field of central user account management in Industrial Automation and Control Systems, such as in Process Control and Substation Automation systems.

### BACKGROUND

Substation Automation systems supervise, protect and control substations in high and medium-voltage electrical power networks, by means of Intelligent Electronic Devices, or Protection and Control devices, allocated to the bays and/or to the primary equipment of the substation. These devices may repeatedly need to be accessed by various users, such as commissioning or maintenance engineers. With the arrival of cyber security requirements and cyber security standards, such as the IEC 62351-8, the principle of central user account management and, for example provision of user credentials to users, has become more prevalent for utilities. In the present context, user credentials include IEC 62351-8 role information defining access rights to a device. User credentials may include, or may be protected by, a user name/password combination, an IEC 62351-8 SW token or a X.509 certificate and associated private key issued by a trusted certificate authority. The certificate and/or the private key of the user may be stored on a physical token such as a USB stick, RFID tag, or Smart Card, and be accessible via an appropriate token reader.

User passwords generally comply with password complexity policies such as minimum length, occurrence of special characters, numbers, capital letters etc. However, known Protection and Control devices operating in industrial or utility applications may be deprived of a standard full-fledged alphanumeric keyboard or touchscreen Likewise, these devices may be deprived of token readers required for local log-on using certificates. Yet on the other hand, known Protection and Control devices still can include a Local Human Machine Interface for local interaction between the user and the device, including a small display and a minimalistic keyboard limited to navigate on preconfigured menus.

The foregoing implies that presenting user credentials at an industrial Protection and Control device is not always feasible or at best very cumbersome to accomplish.

### SUMMARY

A method is disclosed of granting access to an Intelligent Electronic Device (IED) of an Industrial Automation and Control System IACS, wherein the IED has a Local Human Machine Interface LHMI with a restricted IED key set of IED keys, the method comprising: verifying, by an Access Enabler (AE) communicatively connected to the IED, user credentials presented by a user to the AE; generating a temporary session secret consisting of a succession of keys or key combinations chosen from the restricted IED key set; communicating the session secret to the user and communicating the session secret, or a hash of the session secret, to the IED; and. granting IED access to the user when a secret subsequently presented to the IED by the user matches the session secret.

An Access Enabler (AE) is also disclosed for enabling access to an Intelligent Electronic Device (IED) of an Industrial Automation and Control System IACS when the IED is communicatively connected to the AE, the IED having a Local Human Machine Interface (LHMI) with a set of restricted IED key set of IED keys, the AE comprising: a user authentication module for verifying user credentials presented by a user to the AE; a secret generation module for generating a temporary session secret for subsequent IED access of the user to the IED, the session secret consisting of a succession of keys or key combinations chosen from the restricted IED key set; and a communication module for communicating the session secret to the user and for communicating the session secret to the IED.

### BRIEF DESCRIPTION OF THE DRAWINGS

Other features and advantages disclosed herein will become apparent from the following description of exemplary preferred embodiments when read in conjunction with the accompanying drawings, wherein:

FIG. 1 depicts exemplary steps of a central user account management procedure for a Substation Automation SA system according to an embodiment disclosed herein;

FIG. 2 depicts a login sequence diagram according to an exemplary variant embodiment disclosed herein; and

FIG. 3 schematically depicts the front panel of an exemplary LHMI including a screen and a restricted set of keys as well as some other control keys.

### DETAILED DESCRIPTION

Exemplary embodiments as disclosed herein can increase usability of central user account management in Industrial Automation and Control Systems, for example in Substation Automation systems. This can be achieved by a method of and an Access Enabler for granting access to an Intelligent Electronic Device as disclosed herein.

According to exemplary embodiments, a user is granted access to an Intelligent Electronic Device (IED) of a Industrial Automation and Control System (IACS), which IED has a Local Human Machine Interface (LHMI) with a set of IED keys, as follows:
(i) An Access Enabler (AE) application executed by a central user account management computer of the IACS communicatively connected to the IED authenticates the user by verifying user credentials such as a user password or a X.509 certificate that are presented to the AE by a user seeking access to the IED;
(ii) The AE module generates, or establishes, a session secret consisting of a succession of N keys or key combinations chosen, or composed, from the set of IED keys such that the session secret may be entered at the LHMI of the IED by a succession of N keystrokes;
(iii) The session secret is communicated to the user, and the session secret, or a hash of the session secret to prevent against eavesdropping, is communicated to the IED;
(iv) The IED validates a secret presented, or entered, via the LHMI of the IED by the user having physically moved to the IED, and grants IED access to the user in case of matching secrets. The IED concludes on matching secrets by positively comparing the secret with the previously transmitted session secret, or by positively comparing a hash of the secret with the previously transmitted hash of the session secret.

In general, the access control mechanism in IEC 62351-8 is role-based access control (RBAC) either in PULL mode that is transmitting the user name and password, or in PUSH mode that is challenging the private key of the user, as explained in above item (i). The RBAC may reduce the complexity and cost of security administration in networks with large numbers of IEDs. The industrial automation and control systems have an interface for configuring or controlling the IED. The interface can be a LHMI with a restricted IED key set.

As disclosed herein, exemplary embodiments provide a solution for simplified user access to IEDs in industrial or utility operating environments compatible with IEC 62351-8, such as IEDs having a LHMI with a restricted IED key set. A short and temporary session secret can be assigned and issued to a previously authenticated user, and at the same time forwarded to an IED for subsequent local validation of the user having moved to the IED. While the restricted IED key set excludes a full-fledged computer keyboard, it may include ten numeric keys (0 . . . 9), menu driving keys, (e.g., up/down/left/right arrow), selection keys, (e.g., cancel/enter), other single-purpose keys, or any combination thereof. In case of touchpads, an IED key can be represented by a localized image or symbol on a touchscreen; or the IED key can correspond to a gesture on the touchscreen. In this sense the session secret chosen may be considered “IED-compatible”.

In an exemplary embodiment disclosed herein, the AE proceeds to a remote opening, or initiating, of a user session at the IED, which can include instantaneously locking or disabling the screen of the IED. Upon validation of the session secret at the IED, the screen is unlocked, and the user may locally resume the user session. To that purpose and in order for the IED to comply with IEC 62351-8, the IED verifies the identity of the user upon initiation of the user session. This may be achieved by the AE sending username and password to the IED and the IED verifying these credentials (IEC 62351-8 PULL model), and/or by applying a user certificate and the corresponding private key in a challenge response fashion (IEC 62351-8 PUSH model), with the AE accessing the user certificates stored on a user token connected to the central user account management computer. The remote initiation of a screen-locked user session is preferred over an alternative susceptible to identity spoofing attacks, in which alternative the IED verifies the identity of the AE, and the AE exclusively transmits username and session secret to the IED.

For example, the AE application verifies the identity of the IED by opening a Transport Layer Security (TLS) protected communication channel involving use of TLS server certificates, (e.g., by using TLS handshake to perform client authentication). The IED may also check, by consulting specific Certificate Revocation Lists (CRL), whether, at the time of logon to the IED the basic user certificates issued and signed by a trusted Certification Authority have not expired or been revoked.

Specifically, in the IEC 62351-8 PULL model where the user credentials include user identifier and user password, the session secret can be chosen to be shorter, in terms of keystrokes at the LHMI of the IED, than the user password; in other words, the number N is less than a number of successive keys or key combinations required to enter the user password at the LHMI of the IED. Accordingly, as the session secret does not need to comply with the extended password complexity policies that may apply to the user password, there is no need to compose a standard alphanumeric password with the restricted set of keys of the LHMI of the IED.

The session secret may be “temporarily” as already described. The more detailed policy of the session secret for authentication of user may be defined by additional features; e.g., the time period in which the session secret is valid or number of usage until the session secret is invalid. The time period is preferably short; e.g., the session secret is valid for a short time period, such as 1 to 24 hours, preferably for example 1 to 8 hours. If desired, the time period may be also several days, e.g. in the case of a visitor account. Additionally, the numbers of usage of the session secret may be also defined; e.g., the user may use the session secret for authentication once, twice or many times, such as 10 times or 20 times which may be related to the number of the IEDs.

The user can for example select, upon successful authentication, a plurality of IEDs among the totality of IEDs of the IACS that the user intends to access. A single session secret can be subsequently generated and communicated to all selected IEDs for granting IED access to the user without repeated presentation of the user password. Furthermore, the session secret can be provided with a validity period or expiry date, and the IED does not grant access in case the validity period has already expired at the time of validation. Additionally, a user role may be determined and provided, and access restricted in accordance.

Exemplary embodiments also relate to a computer program product including computer program code stored in a non-transitory medium for controlling one or more processors of a specially programmed central user account management computer to perform the functionality of an access enabler as disclosed herein, such as, a computer program product including a non-transitory computer readable medium containing therein the computer program code.

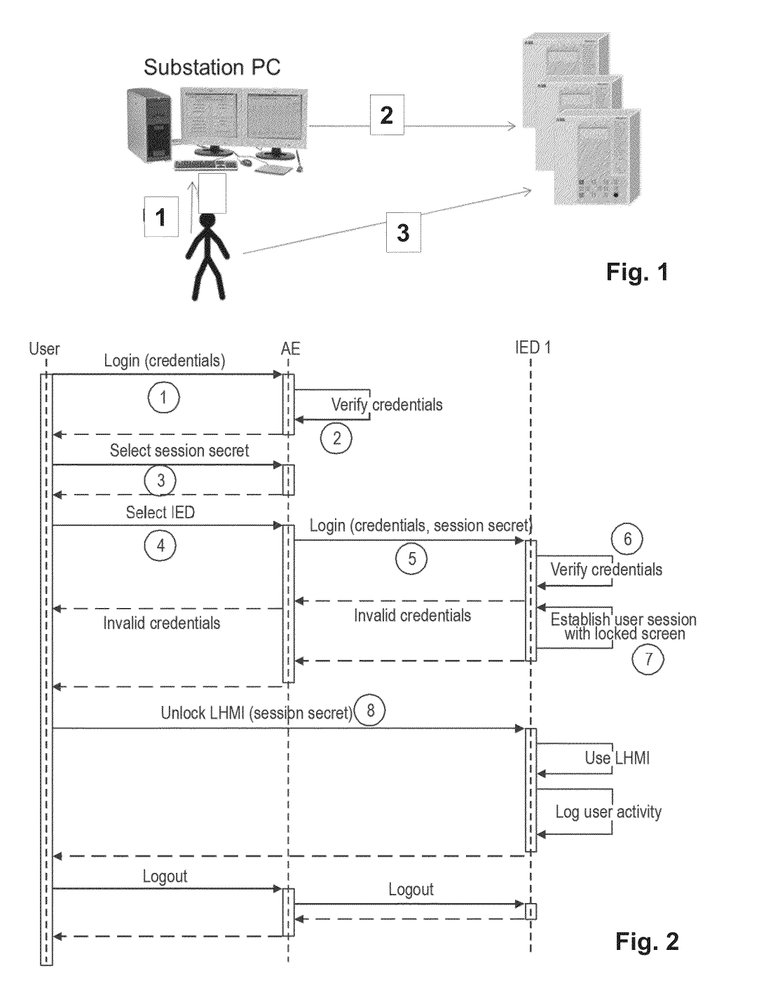

FIG. 1 depicts exemplary steps of a central user account management procedure for a Substation Automation SA system according to an exemplary embodiment disclosed herein.

In a first step, a user authenticates himself, by his credentials and selected role, at an Access Enabler AE application running on a special workstation or substation PC. After authentication, the user selects one or more Intelligent Electronic Device IED of the SA system. The AE and the user establish at least one session secret suitable for subsequent access to the selected IEDs.

In a second step, the AE transmits the user credentials and the negotiated session secret(s) to the selected IEDs in a secure way, (e.g., via SSL).

In a third step, the user physically moves to the IEDs and enters the session secret at the Local Human Machine Interface LHMI to access the IED.

FIG. 2 depicts an exemplary login sequence diagram according to a variant embodiment disclosed herein. The AE application remotely logs into an IED and opens a user session with screen lock. Specifically:
1. The user supplies his or her credentials to the AE application on the central user account management computer.
2. The AE application verifies the credentials by means of a local, replicated database, or using an online account management server.
3. A session secret is established, either generated by the AE application or proposed by the user. The session secret is devised such that it can be easily entered on the IED. It may consist of numbers or a sequence of arrow and other keys present on the IED's LHMI.
4. The user selects an IED and optionally a role to be used for accessing the IED.
5. The AE application employs the user credentials including user role to login to the IED and start a screen locked LHMI session. To this end, according to the IEC 62351-8 PULL model, the user name, user role, user password and session secret are transmitted to the IED. In an exemplary embodiment this requires encrypted communication and prior verification of the identity of the IED.
6. The IED verifies the credentials including role information, which may include comparing a hash of the password transmitted to a hash of the user password previously stored at the IED.
7. The LHMI session is established and protected by the session secret, which implies that no activity other than presentation of a user secret is possible for this session. Following this, the use of the central user account management computer is optional, and may be limited to logout or adding more devices.
8. The user enters the session secret at the LHMI of the IED. If the secret is determined to be valid, the IED screen is unlocked. The user is logged on to the IED and allowed to act according to his or her role.

The approach as described above is entirely compatible with the mechanisms described in the IEC 62351-8 PULL model. In the IEC 62351-8 PUSH model, instead of transmitting user name and user password to the IED in steps 5 and 6, the latter verifies user credentials and user role by challenging the private key of the user. In other words, the IED verifies that the AE has possession of or access to, via its token reader, the private key of the user.

For emergency handling, the user may negotiate an empty session secret. In this case, the user will automatically be logged in to all selected IEDs without entering the session secret to unlock the screen. For security reasons, and/or in case regulations do so require, there must be a configuration option to disable empty secrets.

The system can be extended with several timeouts that are either locally configured on the IED or transmitted along with the user credentials. The timeouts can for example include:
Initial screen lock timeout. The user needs to unlock the IED within this timeout. If not, the session is terminated;
Screen lock inactivity timeout: if the user is inactive for longer that this timeout, the screen will be locked again;
Session inactivity timeout: If the user is inactive for longer than this timeout, the session is closed;
Session timeout: The session will be closed after this timeout regardless of user activity.

There are several options for logout available. For example, the user may log out and close the session at the IED or at the AE application. In the latter case, the AE application closes all HMI sessions on the IEDs.

Because the session secret may be short in absolute terms (e.g., between 4 and 10 keys), it is relatively easy to hack with brute force. The following exemplary steps can be implemented to counter that issue:
The session secret can be short lived, with an initial validity period determined by the time it takes the user to move from the central user account management computer to the most peripheral IED of the system, assumed for example to be in the range of 5 to 30 minutes;
The IED needs to slow down a user who enters a wrong password by, for example, introducing dead-times of 5 minutes after entering it wrong 3 times;
The session secret follows some complexity rules, such as at least 4 digits or 6 arrow keys containing all 4 directions; and/or
Login count at a specific IED in order to prevent a user from using the session secret more than a given number of times.

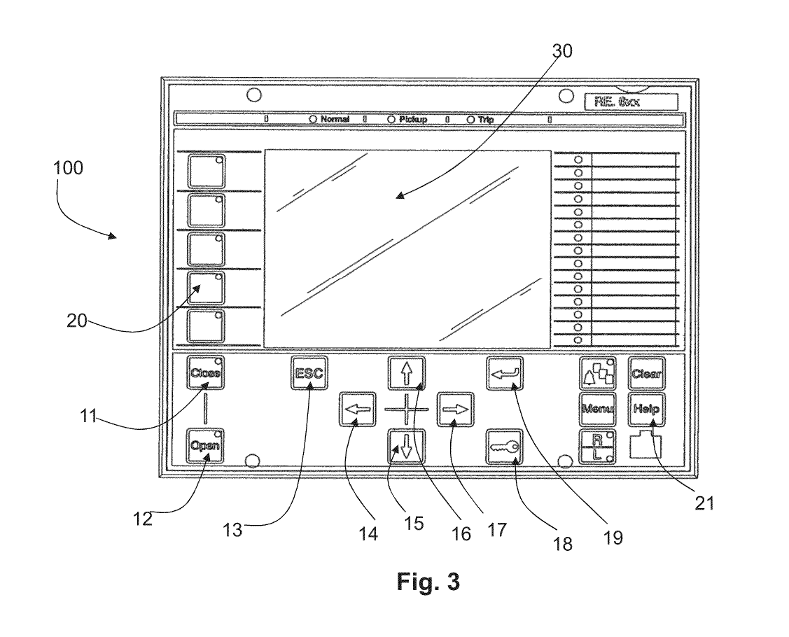

FIG. 3 schematically depicts an exemplary front panel of an exemplary LHMI 100 including a screen 30 and a restricted set of keys 11-19 as well as some other control keys 20-21. As already discussed, these keys at the LHMI of the IED do not include any alphanumeric and numeric keys in order to input username and password for authentication. In other words, the exemplary LHMI at the IED has only a limited number of keys thereby limiting the user input possibilities. However, according to exemplary cyber security policy, the password can include alphanumeric characters.

Some of the illustrated LHMI may include a numeric keypad (not shown) but still without alphanumeric keys. Such a keypad simplifies the input of numeric keystrokes but still has quite limited input possibilities when input of alphanumeric keys are required. The alphanumeric keys may be displayed on the screen. However, for input of each alphanumeric key the user would have to navigate through the alphanumeric key panels displayed on the screen by using the arrow keys and select the desired alphanumeric key by pressing a control key. This can be very time consuming.

The session secret according to exemplary embodiments disclosed herein may be a combination from some of the numeric keys (not shown in the FIG. 3), up/down/left/right arrow keys 14-17, close/open/ESC keys 11-13, return/key keys, and/or other control keys 20-21. These keys may be pressed sequentially. Furthermore, the session secret may also include input by simultaneously pressing of two or more keys. This sequential and simultaneous input of keys may be combined, (e.g., the session secret includes a succession of keys and/or keys combinations).

For instance, a user may input the temporary session secret by consecutively pressing the keys 14, 15, 14, 16 and then simultaneously pressing the keys 16 and 17, and followed by pressing the key 19 to initiate the authentication. This simplified key sequence can be easily input using the restricted key set at the LHMI of the IED. An input of a more complicated username and password including alphanumeric keys is no longer required. This reduces the effort for entering the authentication significantly. The user may use the session secret for authentication as long as it is not expired, which can be defined in the session secret policy. In addition, exemplary embodiments can provide more flexibility for authentication of user, (e.g., the user does not need to find a computer including a full-fledged keyboard).

The screen 30 may be a touch panel. In this case the session secret may be a gesture on the touch screen. The input of the gesture may be sufficient for authentication of the user. However, it is also possible to combine the input of the keystrokes 11-21 with the gesture for the authentication of the user.

Exemplary embodiments can simplify the user authentication at the IED by replacing the user credential having user name and password in alphanumeric characters, with the session secret merely including keys or gestures which can be directly input at the LHMI at the IED. Therefore, the efficient user authentication at the IED as disclosed herein can significantly improve the usability.

Those skilled in the art will appreciate that other features and advantages can be achieved in accordance with embodiments of the presently disclosed inventions. As such, the presently disclosed invention should not be constued as limited to the exemplary disclosed embodiments, but rather is defined by the claims as set forth herein and all embodiments encompassed thereby.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method of granting access to an Intelligent Electronic Device (IED) of an Industrial Automation and Control System IACS, wherein the IED has a Local Human Machine Interface LHMI with a restricted IED key set of IED keys, the method comprising:
verifying, by an Access Enabler (AE) communicatively connected to the IED, user credentials presented by a user to the AE;
generating a temporary session secret consisting of a succession of keys or key combinations chosen from the restricted IED key set;
communicating the session secret to the user and communicating the session secret, or a hash of the session secret, to the IED; and
granting IED access to the user when a secret subsequently presented to the IED by the user matches the session secret.

2. The method according to claim 1, comprising:
opening, by the AE, a user session at the IED on behalf of the user, and locking a screen of the LHMI; and
unlocking, by the IED, the screen upon validation of the session secret presented by the user.

3. The method according to claim 1, wherein the user credentials include a user password, the method comprising:
generating a session secret including a number of keys or key combinations chosen from the IED keys less than a number of keys or key combinations required to enter the password at the LHMI of the IED.

4. The method according to claim 1, comprising:
selecting, by user input, a plurality of IEDs of the IACS; and
generating a single session secret for all selected IEDs.

5. The method according to claim 1, comprising:
generating a session secret including validity period; and
granting IED access unless the validity period has expired.

6. The method according to claim 1, comprising:
communicating, by the AE, a role of the user to the IED; and
granting IED access in accordance therewith.

7. An Access Enabler (AE) for enabling access to an Intelligent Electronic Device (IED) of an Industrial Automation and Control System IACS when the IED is communicatively connected to the AE, the IED having a Local Human Machine Interface (LHMI) with a set of restricted IED key set of IED keys, the AE comprising:
a user authentication module for verifying user credentials presented by a user to the AE;
a secret generation module for generating a temporary session secret for subsequent IED access of the user to the IED, the session secret consisting of a succession of keys or key combinations chosen from the restricted IED key set; and
a communication module for communicating the session secret to the user and for communicating the session secret to the IED.

8. The Access Enabler according to claim 7, comprising: a token reader for accessing user certificates stored on a token, the communication module being configured to access the user certificates in order to respond to a challenge from the IED.

9. The Access Enabler according to claim 7, wherein the communication module is configured to open a user session at the IED and to lock a screen of the LHMI for unlocking upon validation of the session secret presented by the user.

10. The Access Enabler according to claim 7, wherein the secret generation module is configured to generate a single session secret for a plurality of IEDs of the IACS selected by the user.

11. The method according to claim 2, wherein the user credentials include a user password, the method comprising:
generating a session secret including a number of keys or key combinations chosen from the IED keys less than a number of keys or key combinations required to enter the password at the LHMI of the IED.

12. The method according to claim 2, comprising:
selecting, by user input, a plurality of IEDs of the IACS; and
generating a single session secret for all selected IEDs.

13. The method according to claim 2, comprising:
generating a session secret including validity period; and
granting IED access unless the validity period has expired.

14. The method according to claim 2, comprising:
communicating, by the AE, a role of the user to the IED; and
granting IED access in accordance therewith.

15. An Access Enabler (AE) according to claim 7, in combination with an Intelligent Electronic Device (IED) of an Industrial Automation and Control System IACS, for communicatively connecting the IED to the AE, the IED having a Local Human Machine Interface (LHMI) with a set of restricted IED key set of IED keys.

16. The Access Enabler according to claim 15, comprising: a token reader for accessing user certificates stored on a token, the communication module being configured to access the user certificates in order to respond to a challenge from the IED.

17. The Access Enabler according to claim 16, wherein the communication module is configured to open a user session at the IED and to lock a screen of the LHMI for unlocking upon validation of the session secret presented by the user.

18. The Access Enabler according to claim 17, wherein the secret generation module is configured to generate a single session secret for a plurality of IEDs of the IACS selected by the user.
